(19) United States
(12) Patent Application Publication
(10) Pub. No.: US 2026/0208993 A1
(43) Pub. Date: Jul. 23, 2026

(54) SHEET PROCESSING DEVICE AND IMAGE FORMING APPARATUS

(71) Applicant: Kenji Takashima, Numazu Shizuoka (JP)

(72) Inventor: Kenji Takashima, Numazu Shizuoka (JP)

(73) Assignee: ETRIA CO., LTD., Kanagawa (JP)

(21) Appl. No.: 19/267,618

(22) Filed: Jul. 13, 2025

(30) Foreign Application Priority Data
Jan. 17, 2025 (JP) 2025-007044

(51) Int. Cl. B65H 29/14; B65H 31/02; B65H 37/06; B65H 43/00; G03G 15/00

(52) U.S. Cl. CPC B65H 29/14; B65H 31/02; B65H 37/06; B65H 43/00; G03G 15/6538; B65H 2301/44318; B65H 2301/45; B65H 2405/112; B65H 2801/27; G03G 2215/00877

(57) ABSTRACT

A sheet processing device includes a first roller, a second roller, and a cover. The first roller is rotatable around a first rotation axis. The second roller is rotatable around a second rotation axis positioned above the first rotation axis and on a first side of the first rotation axis in a horizontal direction. The second roller comes into contact with the first roller to form a nip. A straight line including a contact line of the nip is defined as a first straight line, and a straight line parallel to the first straight line and passing through the second rotation axis is defined as a second straight line. The cover covers an outer circumference of the second roller on the first side of the second roller in the horizontal direction and has a lower end part disposed between the first straight line and the second straight line.

### CROSS-REFERENCE TO RELATED APPLICATIONS

This application is based upon and claims the benefit of priority from Japanese Patent Application No. 2025-007044, filed on Jan. 17, 2025; the entire contents of which are incorporated herein by reference.

### FIELD

Embodiments described herein relate generally to a sheet processing device and an image forming apparatus.

### BACKGROUND

A sheet processing device having a saddle folding unit is utilized. The saddle folding unit folds a sheet to form a booklet. The formed booklet is discharged from a pair of rollers of a discharge mechanism onto a booklet tray. The booklets are disposed in a stack on the booklet tray. There is a demand for a sheet processing device capable of suppressing decrease in processing quality.

### BRIEF DESCRIPTION OF THE DRAWINGS

FIG. 1 is a schematic configuration view of an image forming apparatus including a sheet processing device of an embodiment.

FIG. 2 is a block diagram showing a functional configuration example of the image forming apparatus.

FIG. 3 is a front cross-sectional view of a booklet discharge unit.

FIG. 4 is an enlarged view of a vicinity of a discharge mechanism in FIG. 3.

FIG. 5 is an enlarged view of a vicinity of a discharge mechanism in a modified example of the embodiment.

FIG. 6 is an operation explanatory view of the discharge mechanism of the embodiment.

FIG. 7 is an operation explanatory view of a discharge mechanism in a conventional technology.

### DETAILED DESCRIPTION

A sheet processing device according to aspect 1 of an embodiment includes a first roller, a second roller, and a cover. The first roller is rotatable around a first rotation axis. The second roller is rotatable around a second rotation axis positioned above the first rotation axis and on a first side of the first rotation axis in a horizontal direction. The second roller comes into contact with the first roller to form a nip, and can convey a saddle-folded booklet obliquely downward by rotating while the booklet is held in the nip. In a cross section perpendicular to the second rotation axis, a straight line including a contact line of the nip is defined as a first straight line, and a straight line parallel to the first straight line and passing through the second rotation axis is defined as a second straight line. A cover covers an outer circumference of the second roller on the first side of the second roller in the horizontal direction and has a lower end part disposed between the first straight line and the second straight line.

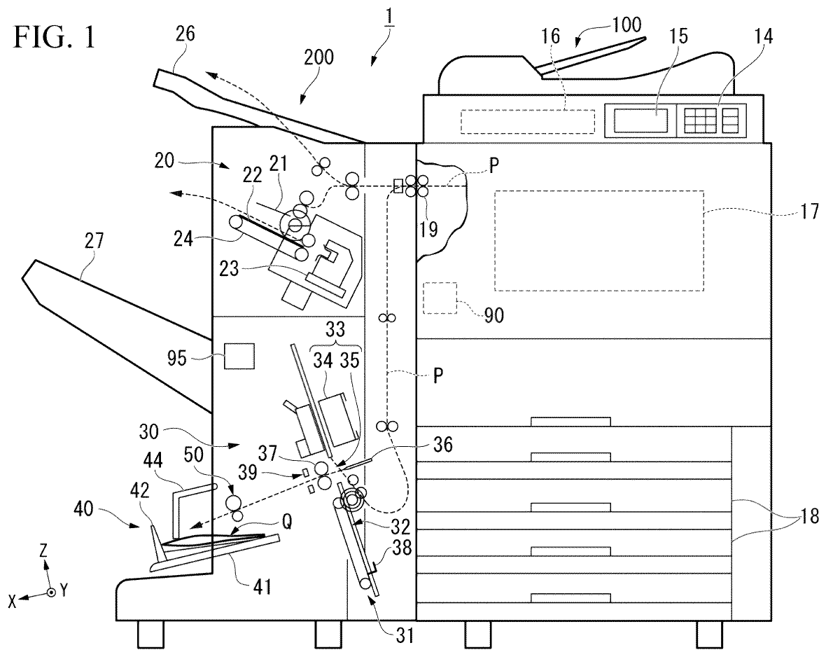

Hereinafter, a sheet processing device and an image forming apparatus according to an embodiment will be described with reference to the drawings. FIG. 1 is a schematic configuration view of an image forming apparatus 1 including a sheet processing device 200 of the embodiment. The image forming apparatus 1 includes an image forming apparatus main body 100 and the sheet processing device 200. The image forming apparatus main body 100 and the sheet processing device 200 are disposed adjacent to each other.

The image forming apparatus main body 100 will be described. The image forming apparatus main body 100 forms an image on a sheet (recording medium) using a recording agent. For example, the sheet may be plain paper or label paper. A specific example of the recording agent is a toner. The toner is either a toner used as a decolorizable recording agent or a toner used as a non-decolorizable recording agent.

For example, the image forming apparatus main body 100 is a multifunction printer. As illustrated in FIG. 1, the image forming apparatus main body 100 includes a display unit 15, an operation unit 14, an image reading unit 16, a printer unit 17, a sheet storage unit 18, a sheet discharge roller 19, and a first control unit 90.

The display unit 15 is an image display device such as a liquid crystal display or an organic EL (Electro Luminescence) display. The display unit 15 displays information of various types related to the image forming apparatus main body 100 and the sheet processing device 200. The operation unit 14 has a plurality of buttons. The operation unit 14 receives operations from a user. The operation unit 14 outputs a signal corresponding to an operation performed by the user to the first control unit 90 of the image forming apparatus main body 100. The display unit 15 and the operation unit 14 may be configured as an integrated touch panel.

The image reading unit 16 reads image information of a reading target as light and darkness. The image reading unit 16 outputs the read image information to the printer unit 17. The sheet storage unit 18 stores sheets to be used for image formation. The sheet storage unit 18 supplies the stored sheets to the printer unit 17.

The printer unit 17 forms an image on a sheet on the basis of image information generated by the image reading unit 16 or image information received via a communication path. The printer unit 17 includes an image forming unit, a transfer unit, and a fixing device. The image forming unit forms an electrostatic latent image on a photosensitive drum on the basis of image information. The image forming unit forms a visible image by attaching toner to the electrostatic latent image. The transfer unit transfers the visible image onto a sheet. The fixing device applies heat and pressure to the toner to fix the visible image onto the sheet.

The sheet discharge roller 19 is disposed near a paper discharge outlet of the image forming apparatus main body 100. The sheet discharge roller 19 sends the sheet on which an image has been formed to the sheet processing device 200. The first control unit 90 controls an operation of each unit of the image forming apparatus main body 100 and the sheet processing device 200.

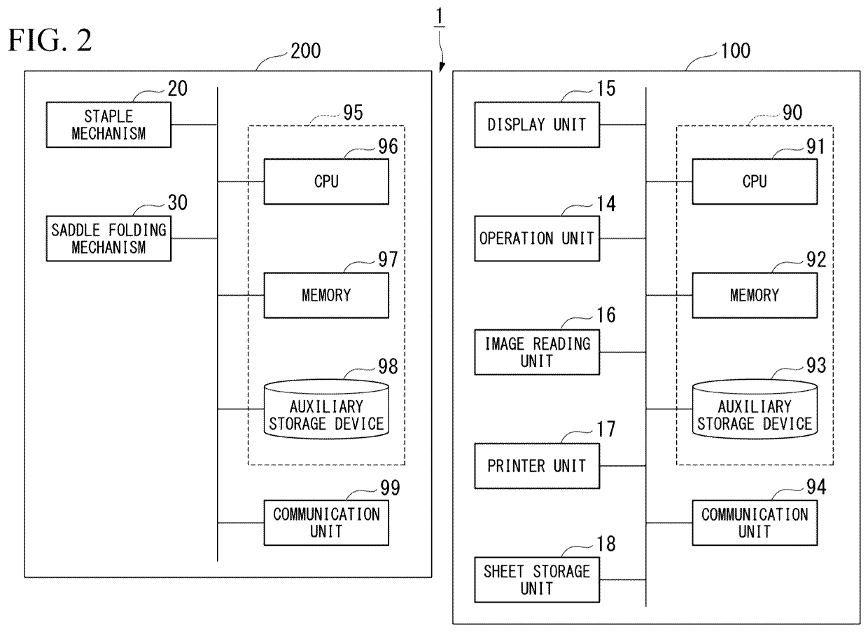

FIG. 2 is a block diagram showing a functional configuration example of the image forming apparatus 1. The image forming apparatus main body 100 includes a central processing unit (CPU) 91, a memory 92, an auxiliary storage device 93, and the like which are connected via a bus, and executes a program. The image forming apparatus main body 100 functions as an apparatus including the display unit 15, the operation unit 14, the image reading unit 16, the printer unit 17, the sheet storage unit 18, and a communication unit 94 by executing the program.

The CPU 91 functions as the first control unit 90 by executing the program stored in the memory 92 and the auxiliary storage device 93. The first control unit 90 controls an operation of each unit of the image forming apparatus main body 100 and the sheet processing device 200. The auxiliary storage device 93 is configured using a storage device such as a magnetic hard disk device or a semiconductor storage device. The auxiliary storage device 93 stores information. The communication unit 94 is configured to include a communication interface for connecting the communication unit 94 to an external device. The communication unit 94 communicates with an external device via the communication interface.

The sheet processing device 200 will be described with reference to FIG. 1. The sheet processing device 200 performs post-processing on a sheet P on which an image has been formed. For example, the post-processing is stapling processing, saddle folding processing, or the like. The sheet processing device 200 includes a staple mechanism 20, a saddle folding mechanism 30, and a second control unit (control unit) 95.

The staple mechanism 20 includes a standby tray 21, a processing tray 22, and a stapler 23. The stapler 23 performs staple processing on circumferential edge portions of a plurality of sheets P. The sheets P that have undergone the staple processing are conveyed by a conveying belt 24 and discharged onto a movable tray 27.

The sheet processing device 200 includes the movable tray 27 and an upper tray 26. The sheets P that have undergone the staple processing are discharged onto the movable tray 27. The sheets P that have not undergone the staple processing are discharged onto the upper tray 26.

The saddle folding mechanism 30 includes a sheet support unit 31, a processing unit 33, and a booklet discharge unit 40. The sheet support unit 31 supports the sheets P. The sheet support unit 31 includes a saddle folding tray 32 and a lifting device 38. The saddle folding tray 32 is able to have the sheets P placed on a surface thereof. The lifting device 38 supports a lower end part of the sheets P placed on the saddle folding tray 32. The lifting device 38 moves up and down to move the sheets P to the processing unit 33.

The processing unit 33 includes a stapling unit 34, a folding unit 35, and a fold reinforcing unit 39. The stapling unit 34 is positioned above the folding unit 35. The stapling unit 34 performs the staple processing at a predetermined position on the sheet P. For example, the predetermined position on the sheet P may be a middle of the sheet P in a longitudinal direction.

The folding unit 35 is positioned at a central portion of the saddle folding mechanism 30. The folding unit 35 folds the middle of the sheet P in a longitudinal direction to form a fold line in the sheet P. The folding unit 35 includes a blade 36 and a pair of folding rollers 37.

The blade 36 has a flat plate shape and a tapered shape. The blade 36 is movable between a front side and a back side of the saddle folding tray 32. The blade 36 can come into contact with the middle of the sheet P in the longitudinal direction. The pair of folding rollers 37 are positioned on a back side of the saddle folding tray 32. The pair of folding rollers 37 are aligned vertically. Rotation axes of the pair of folding rollers 37 are parallel to a horizontal direction.

The fold reinforcing unit 39 is positioned downstream of the pair of folding rollers 37. The fold reinforcing unit 39 reinforces the fold line of the sheet P.

For example, the saddle folding mechanism 30 performs bookbinding processing in which the plurality of sheets P are saddle-folded to form a booklet. The lifting device 38 moves up and down while supporting the sheets P. The lifting device 38 disposes the middle of the sheets P in the longitudinal direction at a position of the stapling unit 34. The stapling unit 34 performs staple processing on the plurality of sheets P. The lifting device 38 moves the plurality of sheets P downward. The lifting device 38 disposes the middle of the sheets P in the longitudinal direction at a position of the folding unit 35. The blade 36 moves from a front side to a back side of the saddle folding tray 32 and pushes the sheets P between the pair of folding rollers 37. The plurality of sheets P are saddle-folded at the middle in the longitudinal direction to form a booklet. The fold reinforcing unit 39 reinforces the fold line of the booklet. As a result, the booklet is completed. The booklet is discharged from the fold reinforcing unit 39 to the booklet discharge unit 40.

The second control unit 95 controls an operation of each unit of the sheet processing device 200. As shown in FIG. 2, the sheet processing device 200 includes a central processing unit (CPU) 96, a memory 97, an auxiliary storage device 98, and the like, which are connected via a bus, and executes the program. The sheet processing device 200 functions as a device including the staple mechanism 20, the saddle folding mechanism 30, and a communication unit 99 by executing the program.

The CPU 96 functions as the second control unit (control unit) 95 by executing the program stored in the memory 97 and the auxiliary storage device 98. The second control unit 95 controls an operation of each unit of the sheet processing device 200. The auxiliary storage device 98 is configured using a storage device such as a magnetic hard disk device or a semiconductor storage device. The auxiliary storage device 98 stores information. The communication unit 99 is configured to include a communication interface for connecting the communication unit 99 to an external device. The communication unit 99 communicates with an external device via the communication interface.

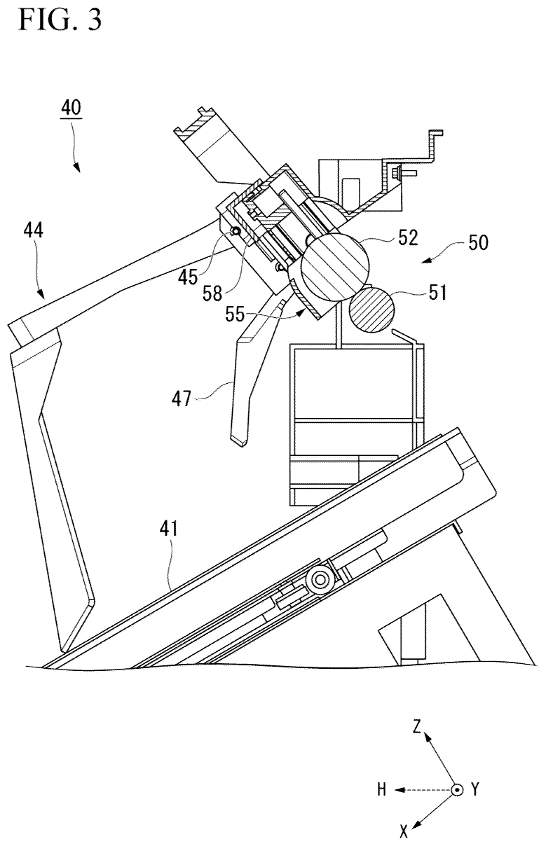

The booklet discharge unit 40 will be described in detail. FIG. 3 is a front cross-sectional view of the booklet discharge unit 40. The booklet discharge unit 40 includes a discharge mechanism 50, a booklet tray 41, a booklet stopper 42 (see FIG. 1), and a damming member 44. As illustrated in FIG. 1, the booklet discharge unit 40 is disposed on a lower side in the sheet processing device 200. The booklet Q is discharged from the discharge mechanism 50 and placed on the booklet tray 41.

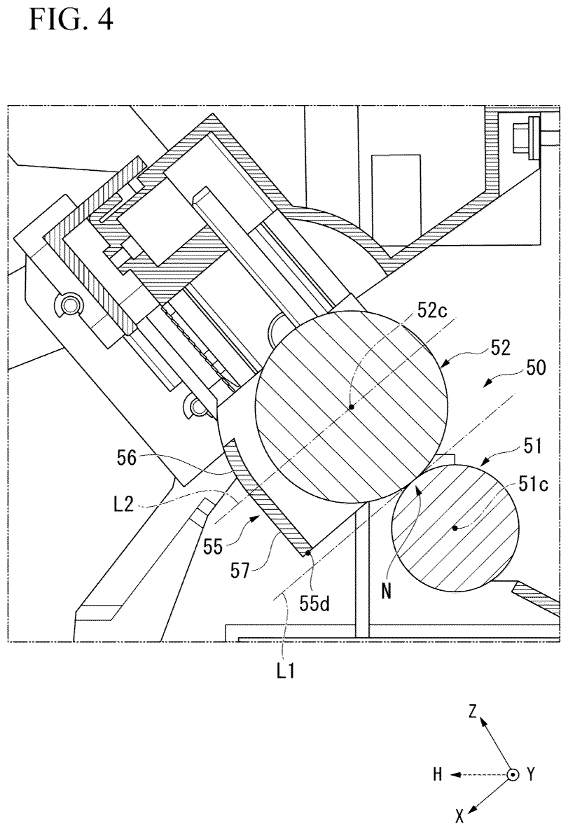

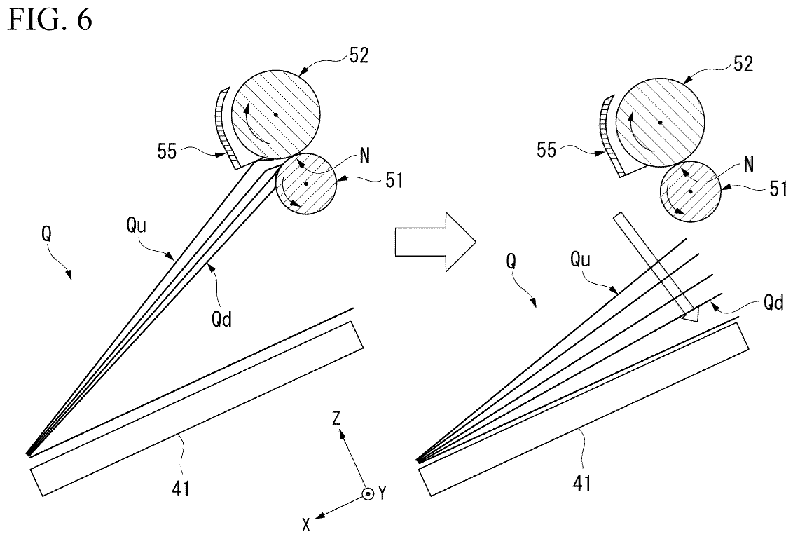

FIG. 4 is an enlarged view of a vicinity of the discharge mechanism 50 of FIG. 3. The discharge mechanism 50 includes a pair of discharge rollers 51 and 52. The pair of discharge rollers 51 and 52 are a lower roller (first roller) 51 and an upper roller (second roller) 52. The lower roller 51 is rotatable around a lower rotation axis (first rotation axis) 51c. The upper roller 52 is rotatable around an upper rotation axis (second rotation axis) 52c. The upper roller 52 can come into contact with the lower roller 51 to form a nip N. The pair of discharge rollers 51 and 52 rotate while the saddle-folded booklet Q (see FIG. 6) is held in the nip N, thereby conveying and discharging the booklet Q obliquely downward.

As a local coordinate system of the booklet discharge unit 40, an X direction, a Y direction, and a Z direction of an orthogonal coordinate system are defined as follows. The Y direction is a direction parallel to the upper rotation axis 52c and the lower rotation axis 51c. The X direction is a direction parallel to a contact line of the nip N in a cross section perpendicular to the upper rotation axis 52c. A +X side is a downstream side of the nip N in a conveyance and discharge direction of the booklet Q. The Z direction (first direction) is a direction in which the lower rotation axis 51c and the upper rotation axis 52c are aligned. A +Z side is a side toward the upper rotation axis 52c from the lower rotation axis 51c.

The upper rotation axis 52c is positioned above the lower rotation axis 51c in the vertical direction. The upper rotation axis 52c is on a first side of the lower rotation axis 51c in a horizontal direction. The first side (+H side) in the horizontal direction of the lower rotation axis 51c is a side that forms an acute angle with the +X side of the lower rotation axis 51c. Thereby, the pair of discharge rollers 51 and 52 convey and discharge the booklet Q obliquely downward to the +X side.

One of the upper roller 52 and the lower roller 51 is a drive roller, and the other is a driven roller. The drive roller is rotationally driven by a motor (not illustrated). The driven roller rotates in accordance with rotation of the drive roller. For example, the lower roller 51 is a drive roller and the upper roller 52 is a driven roller. Conversely, the upper roller 52 may be a drive roller and the lower roller 51 may be a driven roller.

The booklet tray 41 is formed in a flat plate shape parallel to an XY plane. The booklet tray 41 is disposed on the +X side of the discharge mechanism 50 and below it in the vertical direction. The booklet Q discharged from the discharge mechanism 50 is placed on an upper surface of the booklet tray 41 on the +Z side.

The booklet stopper 42 is fixed to the upper surface of the booklet tray 41 on the +Z side as illustrated in FIG. 1. The booklet stopper 42 is disposed near an end part of the booklet tray 41 on the +X side. The booklet Q placed on the upper surface of the booklet tray 41 can come into contact with a side surface of the booklet stopper 42 on a −X side.

The damming member 44 is disposed on the +Z side of the booklet tray 41 as illustrated in FIG. 3. The damming member 44 is disposed on the +X side of the discharge mechanism 50 and on the −X side of the booklet stopper 42 (see FIG. 1). The damming member 44 is formed in an L shape when viewed from the Y direction. The damming member 44 is rotatable around a rotation shaft 45. A distal end of the booklet Q discharged from the nip N of the discharge mechanism 50 comes into contact with the damming member 44. The damming member 44 temporarily holds the booklet Q. The booklet Q discharged later is placed on the +Z side of the booklet Q previously discharged and held by the damming member 44. When the distal end of the plurality of booklets Q comes into contact with the damming member 44, the damming member 44 rotates to the +Z side. The booklet Q passes through the −Z side of the damming member 44 and moves to the booklet stopper 42.

The booklet discharge unit 40 may include an opening stopper member 47. The opening stopper member 47 is disposed on the +Z side of the booklet tray 41. The opening stopper member 47 is disposed on the +X side of the discharge mechanism 50 and on the −X side of the damming member 44. The opening stopper member 47 comes into contact with an upper surface of the booklet Q placed on the booklet tray 41. The opening stopper member 47 suppresses upward opening of the saddle-folded booklet Q. The pair of discharge rollers 51 and 52 are separated into two locations in the Y direction and disposed with the opening stopper member 47 sandwiched therebetween.

As illustrated in FIG. 3, the discharge mechanism 50 has a cover 55. The cover 55 is formed of a resin material or the like. The cover 55 covers an outer circumference of the upper roller 52 on the first side (+H side) of the upper roller 52 in the horizontal direction. The cover 55 extends across an entire range of the upper roller 52 in the Y direction. An end part of the cover 55 in the Y direction covers an end surface of the upper roller 52 in the Y direction.

FIGS. 3 and 4 are cross sections perpendicular to the upper rotation axis 52c. In FIG. 4, a straight line including the contact line of the nip N is defined as a first straight line L1. A straight line parallel to the first straight line L1 and passing through the upper rotation axis 52c is defined as a second straight line L2. A lower end part 55d of the cover 55 is disposed between the first straight line L1 and the second straight line L2 in the Z direction.

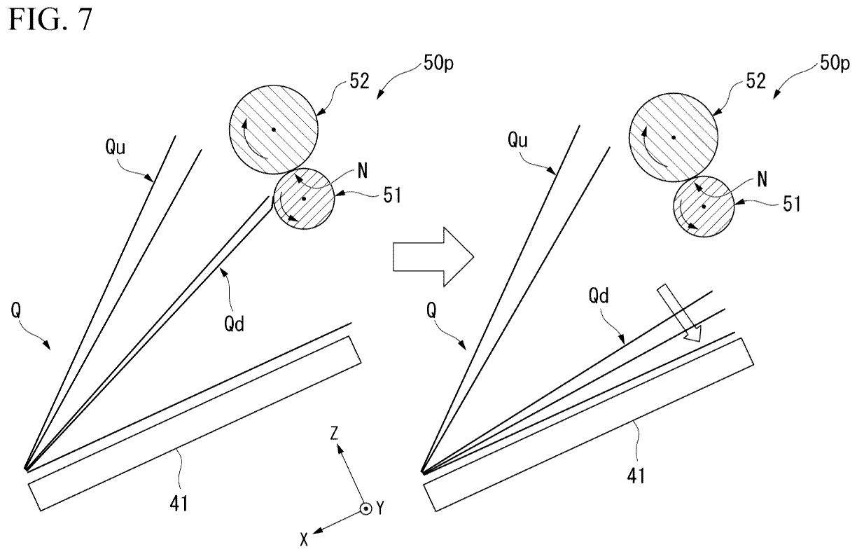

FIG. 7 is an operation explanatory view of a discharge mechanism 50p in a conventional technology. The pair of discharge rollers 51 and 52 rotate while the saddle-folded booklet Q is held in the nip N, thereby discharging the booklet Q to the +X side.

As illustrated in the left view of FIG. 7, the discharged booklet Q spreads vertically. That is, a booklet lower part Qd below the fold line of the booklet Q and a booklet upper part Qu above the fold line are vertically separated. An end part of the booklet lower part Qd on the −X side comes into contact with an outer circumferential surface of the lower roller 51. An end part of the booklet upper part Qu on the −X side flips upward to the +Z side of the nip N.

As illustrated in the right view of FIG. 7, the booklet lower part Qd is scraped downward to the −Z side by rotation of the lower roller 51. Even if the booklet lower part Qd is scraped downward, the booklet upper part Qu remains on the +Z side of the nip N. Following the preceding booklet Q, the subsequent booklet Q is discharged. The subsequent booklet Q enters between the booklet upper part Qu and the booklet lower part Qd of the preceding booklet Q. Thereby, poor stacking of the booklet Q occurs.

FIG. 6 is an operation explanatory view of the discharge mechanism 50 of the embodiment. As illustrated in the left view of FIG. 6, an end part of the booklet upper part Qu on the −X side comes into contact with the lower end part 55d of the cover 55. The upward flipping of the booklet upper part Qu to the +Z side is restricted. A part of the booklet upper part Qu comes into contact with an outer circumferential surface of the lower roller 51. As illustrated in the right view of FIG. 6, the part of the booklet upper part Qu is scraped downward to the −Z side by the rotation of the lower roller 51. In conjunction with this, a remaining part of the booklet upper part Qu also falls to the −Z side. The entire booklet Q falls to the −Z side of the nip N. Following the preceding booklet Q, the subsequent booklet Q is discharged. The subsequent booklet Q is placed on the +Z side of the booklet upper part Qu of the preceding booklet Q. Thereby, poor stacking of the booklet Q is suppressed.

As described above, the lower end part 55d of the cover 55 is disposed between the first straight line L1 and the second straight line L2 in the Z direction. The lower end part 55d of the cover 55 is disposed as close as possible to the −Z side within a range that does not blocking the +X side of the nip N. Thereby, the upward flipping of the booklet upper part Qu to the +Z side is restricted. Most of the booklet upper part Qu comes into contact with the outer circumferential surface of the lower roller 51. The entire booklet Q is likely to fall to the −Z side. Therefore, poor stacking of the booklet Q is suppressed.

In the cover 55, the +Z side of the second straight line L2 is a cover upper part 56, and the −Z side of the second straight line L2 is a cover lower part 57. In FIG. 4, the cover upper part 56 has an arc shape centered on the upper rotation axis 52c. The cover lower part 57 is linear and extends to the −Z side from the lower end part of the cover upper part 56. The lower end part 55d of the cover lower part 57 is spaced apart to the +X side from an outer circumferential surface of the upper roller 52. Thereby, the booklet upper part Qu is less likely to flip upward to the +Z side through the +X side of the cover 55. Therefore, poor stacking of the booklet Q is suppressed.

In the saddle folding mechanism 30 illustrated in FIG. 1, the middle of the sheet P in the longitudinal direction is saddle-folded to form the booklet Q. In the saddle folding mechanism 30, the sheets P of various sizes are processed. A-series sizes such as A3 and A4 are specified in the international standard ISO 216, which defines paper dimensions. B-series sizes such as B5 are specified in ISO 216 or the Japanese Industrial Standards JIS-B series. Envelope sizes are specified in ISO 269 as a C series. LT, which is a letter size, is specified as ANSI A in the American National Standards Institute ANSI/ASME Y14.1. LG is legal size. ST-R is a statement size, which is half the letter size.

As described above, the distal end of the booklet Q discharged from the discharge mechanism 50 illustrated in FIG. 3 comes into contact with the damming member 44. The large-sized booklet Q comes into contact with the damming member 44 during discharge or immediately after being discharged by the discharge mechanism 50. A small-sized booklet Q falls onto the booklet tray 41 after being discharged by the discharge mechanism 50, slides along the upper surface of the booklet tray 41, and comes into contact with the damming member 44. A time from being discharged by the discharge mechanism 50 to coming into contact with the damming member 44 is longer for the small-sized booklet Q than for the large-sized booklet Q. The middle in the longitudinal direction of an A4-sized sheet is saddle-folded to form an A5-sized booklet Q. The A5-sized booklet Q is the smallest size of the booklet Q.

The second control unit 95 controls the rotation of the lower roller 51 serving as a drive roller. The second control unit 95 continues to rotate the lower roller 51 until the distal end of the booklet Q comes into contact with the damming member 44 after at least the A5-sized booklet Q is discharged from the nip N of the discharge mechanism 50. The second control unit 95 continues to rotate the lower roller 51 for the same period of time after booklets Q of other sizes are discharged by the discharge mechanism 50. Thereby, the lower roller 51 continues to rotate until the booklets Q of all sizes come into contact with the damming member 44. Due to the rotation of the lower roller 51, a part of the booklet lower part Qd and booklet upper part Qu are scraped downward to the −Z side. Therefore, poor stacking of the booklet Q is suppressed.

The upper roller 52 serving as a driven roller is biased toward the lower roller 51 serving as a drive roller. When a thick sheet is saddle-folded, a thick booklet Q is formed. When the thick booklet Q enters the nip N of the discharge mechanism 50, the upper roller 52 moves to the +Z side. This makes it easier for the thick booklet Q to enter the nip N, thereby suppressing a discharge failure of the thick booklet Q. The cover 55 is movable in the Z direction together with the upper roller 52. When the thick booklet Q enters the nip N, the cover 55 moves to the +Z side together with the upper roller 52. Even when the thick booklet Q enters the nip N, the cover 55 does not block the +X side of the nip N. Thereby, a discharge failure of the thick booklet Q is suppressed.

The booklet Q discharged from the discharge mechanism 50 is placed on the booklet tray 41. The user of the image forming apparatus 1 reaches out to the booklet tray 41 and picks up the booklet Q. As illustrated in FIG. 1, the upper roller 52 is disposed near the outside of the image forming apparatus 1. There is a likelihood that a user's hand may come into contact with the rotating upper roller 52. As illustrated in FIG. 4, the cover 55 covers the outer circumference of the upper roller 52 on the first side (+H side) of the upper roller 52 in the horizontal direction. The +H side of the upper roller 52 corresponds to an outer side of the image forming apparatus 1. Thereby, a contact of the user's hand with the upper roller 52 can be suppressed.

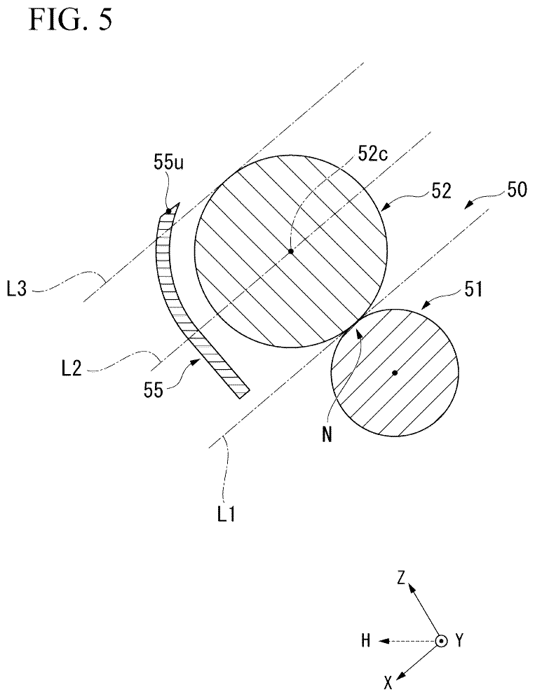

FIG. 5 is an enlarged view of a vicinity of the discharge mechanism 50 in a modified example of the embodiment. FIG. 5 is a cross section perpendicular to the upper rotation axis 52c. In FIG. 5, a straight line parallel to the first straight line L1 and tangent to the outer circumference of the upper roller 52 on the +Z side (upper side) of the upper rotation axis 52c is defined as a third straight line L3. It is desirable that an upper end part 55u of the cover 55 be disposed on the +Z side (upper side) of the third straight line L3. Thereby, most of the first side (+H side) of the upper roller 52 in the horizontal direction is covered by the cover 55. A contact of the user's hand with the upper roller 52 can be suppressed.

As described above, the cover 55 extends across the entire range of the upper roller 52 in the Y direction. Thereby, a contact of the user's hand with the upper roller 52 can be suppressed. As illustrated in FIG. 3, an exterior member 58 of the sheet processing device 200 is disposed on the +Z side of the upper roller 52. It is desirable to form the exterior member 58 so that a lower end part of the exterior member 58 on the −Z side is disposed near the upper roller 52. Even in this case, a contact of the user's hand with the upper roller 52 can be suppressed.

As described above in detail, the sheet processing device 200 of the embodiment includes the lower roller 51, the upper roller 52, and the cover 55. The lower roller 51 is rotatable around the lower rotation axis 51c. The upper roller 52 is rotatable around the upper rotation axis 52c that is above the lower rotation axis 51c and is positioned on the first side in the horizontal direction of the lower rotation axis 51c. The upper roller 52 can form the nip N by coming into contact with the lower roller 51, and can convey the saddle-folded booklet Q obliquely downward by rotating while the booklet Q is held in the nip N. In a cross section perpendicular to the upper rotation axis 52c, a straight line including a contact line of the nip N is defined as the first straight line L1, and a straight line parallel to the first straight line L1 and passing through the upper rotation axis 52c is defined as a second straight line L2. The cover 55 covers an outer circumference of the upper roller 52 on the first side of the upper roller 52 in the horizontal direction and has the lower end part 55d disposed between the first straight line L1 and the second straight line L2.

The booklet upper part Qu of the booklet Q discharged from the nip N flips upward to the +Z side of the nip N. The lower end part 55d of the cover 55 is disposed near the +Z side of the nip N. The lower end part 55d of the cover 55 restricts the upward flipping of the booklet upper part Qu to the +Z side. The entire booklet Q is likely to fall to the −Z side of the nip N. Poor stacking of the booklet Q is suppressed, and decrease in processing quality of the sheet processing device 200 is suppressed. Since the cover 55 covers the outer circumference of the upper roller 52, a contact of the user's hand with the upper roller 52 can be suppressed.

In a cross section perpendicular to the upper rotation axis 52c, a straight line parallel to the first straight line L1 and tangent to the outer circumference of the upper roller 52 above the upper rotation axis 52c is defined as the third straight line L3. The upper end part 55u of the cover 55 is disposed above the third straight line L3. Thereby, most of the upper roller 52 is covered by the cover 55. Therefore, a contact of the user's hand with the upper roller 52 can be suppressed.

The cover 55 extends across an entire axial range of the upper roller 52. Thereby, a contact of the user's hand with the upper roller 52 can be suppressed.

One of the lower roller 51 and the upper roller 52 is a drive roller, and the other is a driven roller. The sheet processing device 200 further includes the second control unit 95 and the damming member 44. The second control unit 95 controls rotation of the drive roller. A distal end of the booklet Q discharged from the nip N can come into contact with the damming member 44. The second control unit 95 continues to rotate the drive roller until the distal end of a A5-sized booklet Q comes into contact with the damming member 44 after at least the A5-sized booklet Q is discharged from the nip N.

Thereby, the lower roller 51 and the upper roller 52 continue to rotate until the booklets Q of all sizes come into contact with the damming member 44. Due to rotation of the lower roller 51, the booklet Q is scraped downward to the −Z side. Thereby, poor stacking of the booklet Q is suppressed, and decrease in processing quality of the sheet processing device 200 is suppressed.

A direction in which the lower rotation axis 51c and the upper rotation axis 52c are aligned is defined as the Z direction. The cover 55 is movable in the Z direction together with the upper roller 52. When the thick booklet Q enters the nip N, the cover 55 moves to the +Z side together with the upper roller 52. Since the cover 55 does not block the +X side of the nip N, a discharge failure of the thick booklet Q is suppressed.

According to at least one embodiment described above, the cover 55 covers an outer circumference of the upper roller 52 on the first side of the upper roller 52 in the horizontal direction, and has the lower end part 55d disposed between the first straight line L1 and the second straight line L2. Thereby, decrease in processing quality of the sheet processing device 200 can be suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet processing device comprising:
a first roller rotatable around a first rotation axis;
a second roller rotatable around a second rotation axis positioned above the first rotation axis and on a first side of the first rotation axis in a horizontal direction, configured to come into contact with the first roller to form a nip, and configured to convey a saddle-folded booklet obliquely downward by rotating while the booklet is held in the nip; and
a cover covering an outer circumference of the second roller on the first side of the second roller in the horizontal direction and having a lower end part disposed between a first straight line and a second straight line when a straight line including a contact line of the nip is defined as the first straight line, and a straight line parallel to the first straight line and passing through the second rotation axis is defined as the second straight line in a cross section perpendicular to the second rotation axis.

2. The sheet processing device according to claim 1, wherein when a straight line parallel to the first straight line and tangent to an outer circumference of the second roller above the second rotation axis is defined as a third straight line in a cross section perpendicular to the second rotation axis, an upper end part of the cover is disposed above the third straight line.

3. The sheet processing device according to claim 1, wherein the cover extends across an entire axial range of the second roller.

4. The sheet processing device according to claim 1, including the first roller and the second roller, one of which serves as a drive roller and the other serves as a driven roller, the sheet processing device further comprising:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

5. The sheet processing device according to claim 1, wherein when a direction in which the first rotation axis and the second rotation axis are aligned is defined as a first direction, the cover is movable in the first direction together with the second roller.

6. The sheet processing device according to claim 2, wherein the cover extends across an entire axial range of the second roller.

7. The sheet processing device according to claim 2, including the first roller and the second roller, one of which serves as a drive roller and the other serves as a driven roller, the sheet processing device further comprising:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

8. The sheet processing device according to claim 2, wherein when a direction in which the first rotation axis and the second rotation axis are aligned is defined as a first direction, the cover is movable in the first direction together with the second roller.

9. The sheet processing device according to claim 6, including the first roller and the second roller, one of which serves as a drive roller and the other serves as a driven roller, the sheet processing device further comprising:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

10. The sheet processing device according to claim 9, wherein when a direction in which the first rotation axis and the second rotation axis are aligned is defined as a first direction, the cover is movable in the first direction together with the second roller.

11. An image forming apparatus comprising:
an image forming apparatus main body including a sheet storage unit storing a sheet, and a printer unit forming an image on the sheet supplied from the sheet storage unit; and
a sheet processing device performing saddle folding processing on the sheet on which an image is formed, wherein
the sheet processing device includes:
a first roller rotatable around a first rotation axis;
a second roller rotatable around a second rotation axis positioned above the first rotation axis and on a first side of the first rotation axis in a horizontal direction, configured to come into contact with the first roller to form a nip, and configured to convey a saddle-folded booklet obliquely downward by rotating while the booklet is held in the nip; and
a cover covering an outer circumference of the second roller on the first side of the second roller in the horizontal direction and having a lower end part disposed between a first straight line and a second straight line when a straight line including a contact line of the nip is defined as the first straight line, and a straight line parallel to the first straight line and passing through the second rotation axis is defined as the second straight line in a cross section perpendicular to the second rotation axis.

12. The image forming apparatus according to claim 11, wherein when a straight line parallel to the first straight line and tangent to an outer circumference of the second roller above the second rotation axis is defined as a third straight line in a cross section perpendicular to the second rotation axis, an upper end part of the cover is disposed above the third straight line.

13. The image forming apparatus according to claim 11, wherein the cover extends across an entire axial range of the second roller.

14. The image forming apparatus according to claim 11, including the first roller and the second roller, one of which serves as a drive roller and the other serves as a driven roller, the sheet processing device further including:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

15. The image forming apparatus according to claim 11, wherein when a direction in which the first rotation axis and the second rotation axis are aligned is defined as a first direction, the cover is movable in the first direction together with the second roller.

16. The image forming apparatus according to claim 12, wherein the cover extends across an entire axial range of the second roller.

17. The image forming apparatus according to claim 12, including the first roller and the second roller, one of which serves as a drive roller and the other serves as a driven roller, the sheet processing device further including:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

18. The image forming apparatus according to claim 12, wherein when a direction in which the first rotation axis and the second rotation axis are aligned is defined as a first direction, the cover is movable in the first direction together with the second roller.

19. The image forming apparatus according to claim 16, including the first roller and the second roller, one of which serves as a drive roller and the other serves as a driven roller, the sheet processing device further including:
a control unit configured to control rotation of the drive roller; and
a damming member with which a distal end of the booklet discharged from the nip is able to come into contact, wherein
the control unit continues to rotate the drive roller until the distal end of the booklet comes into contact with the damming member after at least an A5-sized booklet is discharged from the nip.

20. The image forming apparatus according to claim 19, wherein when a direction in which the first rotation axis and the second rotation axis are aligned is defined as a first direction, the cover is movable in the first direction together with the second roller.
